(19) United States
(12) Patent Application Publication
(10) Pub. No.: US 2012/0205946 A1
(43) Pub. Date: Aug. 16, 2012

(54) HVAC SYSTEM FOR A WORK VEHICLE

(76) Inventor: Lance A. TAYLOR, Wichita, KS (US)

(21) Appl. No.: 13/116,050

(22) Filed: May 26, 2011

Related U.S. Application Data
(60) Provisional application No. 61/463,112, filed on Feb. 11, 2011.

(51) Int. Cl. B60H 1/26; B60S 1/58; B60S 1/54

(52) U.S. Cl. 296/190.09; 454/124

(57) ABSTRACT

An HVAC system for a cab of a work vehicle includes features to urge airflow within the cab between an inlet and a plurality of outlets. The circulating airflow removes a non-transparent layer of a phase of evaporable matter forming on a surface of viewing regions without a heating component at least partially covering or embedded in at least one of the viewing regions.

### RELATED APPLICATION

This application claims priority to U.S. Provisional Patent Application Ser. No. 61/463,112, filed Feb. 11, 2011, entitled “Circulating Airflow Rear Window Defroster.”

### FIELD OF THE INVENTION

The present invention generally relates to HVAC systems and, more particularly, to an HVAC system for use with an operator cab of a work vehicle.

### BACKGROUND OF THE INVENTION

A work vehicle, such as a skid steer or wheel loader is commonly used to load and move substantial volumes of dirt and like material from one location to another. A conventional wheel loader includes a relatively large frame that is supported for self-propelled movement over land by pairs of air-filled pneumatic tires or tracks and has a bucket or implement mounted to one end thereof. The bucket or implement can be selectively elevated to a position above side panels on a wheel loader and can be selectively tilted to “dump” materials therefrom.

To enhance operator comfort, a heating, ventilation and air conditioning (HVAC) system can be incorporated into an operator cab. However, wheel loaders and other work vehicles have a large amount of viewing area provided to enhance an operator's ability to observe the wheel loader and its relation with the surrounding environment. This large amount of viewing area must be kept clear from condensation, including fog or frost to permit consistent operator viewing, both for the safety of the operator and for others. As a result, industry standards have mandated defrosting time frames, requiring additional heater grids applied to at least portions of the viewing area of operator viewing areas of known construction. Such additional heaters add expense to the work vehicle.

Thus, there is a need and a desire for an HVAC system for use in a work vehicle that is inexpensive, easy to operate and does not require additional heaters or heating equipment that is applied to the viewing areas.

### SUMMARY OF THE INVENTION

Other features and advantages of the present invention will be apparent from the following more detailed description of the preferred embodiment, taken in conjunction with the accompanying drawings which illustrate, by way of example, the principles of the invention.

The present invention relates to an HVAC system for a cab of a work vehicle including a forward portion of the cab including a forward viewing region. The forward viewing region is generally oriented at an acute angle sloping toward a rear portion of the cab. A curved rear viewing region extends between a top of the cab and the rear portion of the cab. An inlet of the HVAC system is positioned along the rear portion of the cab beneath the rear viewing region. A conduit extends from the inlet toward the forward portion of the cab, the conduit including a plurality of outlets formed near the forward portion of the cab. An air moving device is positioned inside the conduit for urging airflow from the plurality of outlets toward the inlet. The airflow between the plurality of outlets and the inlet is configured to circulate along the forward viewing region toward the rear viewing region to remove a non-transparent layer of a phase of evaporable matter forming on a surface from the forward viewing region and the rear viewing region without a heating component at least partially covering or embedded in at least one of the forward viewing region and the rear viewing region.

The present invention further relates to a work vehicle including a motor secured to a frame for activating a driving device for selectably moving the frame. An operator cab is supported by the frame. An HVAC system for a cab of a work vehicle includes a forward portion of the cab including a forward viewing region, the forward viewing region generally oriented at an acute angle sloping toward a rear portion of the cab. A curved rear viewing region extends between a top of the cab and the rear portion of the cab. An inlet of the HVAC system is positioned along the rear portion of the cab beneath the rear viewing region. A conduit extends from the inlet toward the forward portion of the cab, the conduit including a plurality of outlets formed near the forward portion of the cab. An air moving device is positioned inside the conduit for urging airflow from the plurality of outlets toward the inlet. The airflow between the plurality of outlets and the inlet is configured to circulate along the forward viewing region toward the rear viewing region to remove a non-transparent layer of a phase of evaporable matter forming on a surface from the forward viewing region and the rear viewing region without a heating component at least partially covering or embedded in at least one of the forward viewing region and the rear viewing region.

The present invention yet further relates to a work vehicle including a motor secured to a frame for activating a driving device for selectably moving the frame. An operator cab is supported by the frame. An HVAC system for a cab of a work vehicle includes a forward portion of the cab including a forward viewing region, the forward viewing region generally oriented at an acute angle sloping toward a rear portion of the cab. A curved rear viewing region extends between a top of the cab and the rear portion of the cab. An inlet of the HVAC system is positioned along the rear portion of the cab beneath the rear viewing region. A conduit extends from the inlet toward the forward portion of the cab, the conduit including a plurality of outlets formed near the forward portion of the cab The conduit includes bifurcated portions extending between the inlet and the forward portion of the cab. An air moving device is positioned inside the conduit for urging airflow from the plurality of outlets toward the inlet. The airflow between the plurality of outlets and the inlet is configured to circulate along the forward viewing region toward the rear viewing region to remove a non-transparent layer of a phase of evaporable matter forming on a surface from the forward viewing region and the rear viewing region without a heating component at least partially covering or embedded in at least one of the forward viewing region and the rear viewing region.

An advantage of the present invention is an HVAC system that quickly clears a non-transparent layer of a phase of evaporable matter, such as fog or frost forming on a surface from viewing areas without requiring additional heaters or heating devices.

Numerous other features and advantages of the present invention will become readily apparent from the following detailed description, the accompanying drawings, and the appended claims.

### BRIEF DESCRIPTION OF THE DRAWINGS

FIG. 1 is a forward-looking upper perspective view of an exemplary embodiment of a work vehicle including an HVAC system of the present disclosure.

FIG. 2 is a partial cutaway front view of the work vehicle of FIG. 1 of the present disclosure.

FIG. 3 is a cross-section taken along line 3-3 of FIG. 1 of the present disclosure.

### DETAILED DESCRIPTION OF THE INVENTION

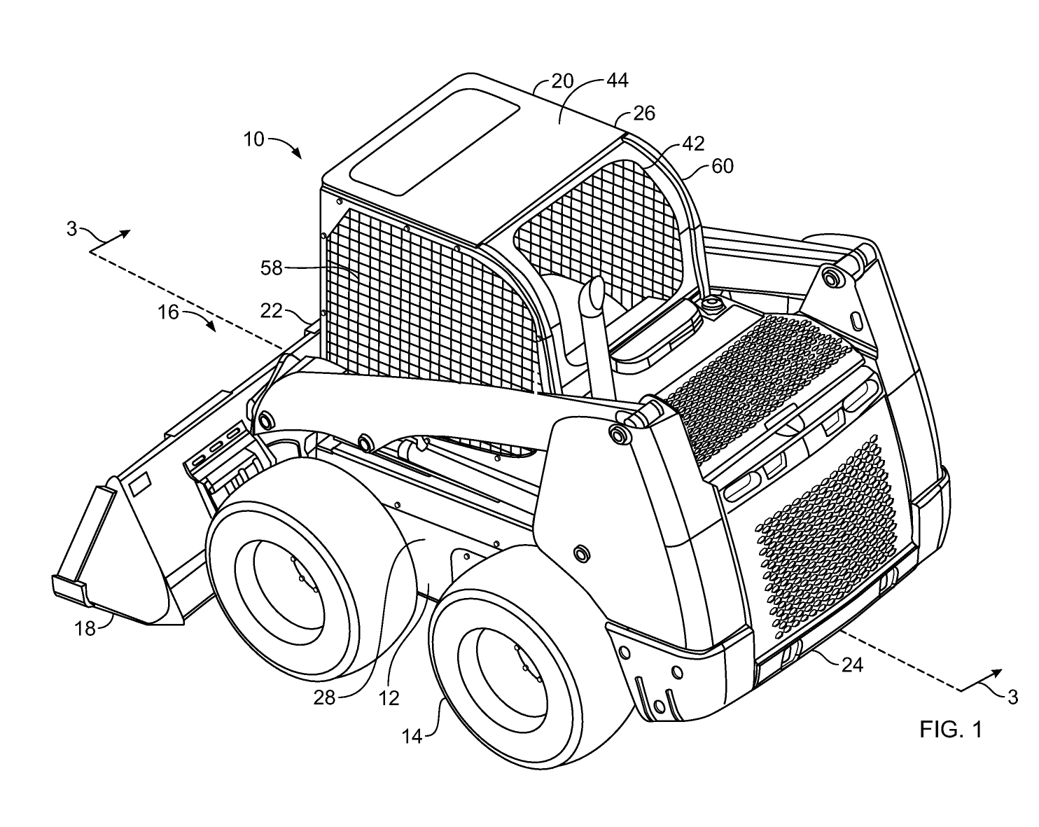

FIG. 1 shows a work vehicle 10 provided with a frame 12 that rotatably carries a driving device 14, such as a plurality of wheels, although in another embodiment, tracks may be used or activated to selectably move the vehicle. A lifting structure 16 includes an arrangement of structural members and actuators controllable by an operator (not shown) to manipulate an implement 18 to perform work. Frame 12 structurally supports an operator cab 20 or cab to surround and protect the operator, which frame 12 includes a front end 22 facing implement 18 and an opposed back end 24 with ends 22, 24 positioned between opposed lateral sides 26, 28 of the frame.

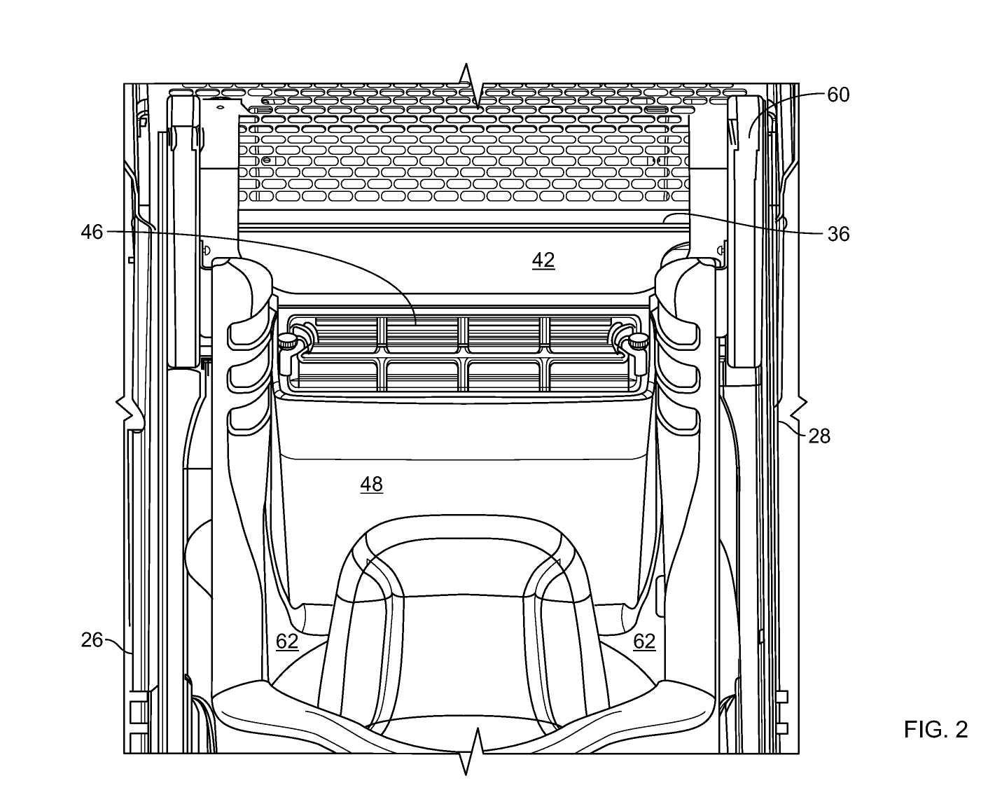

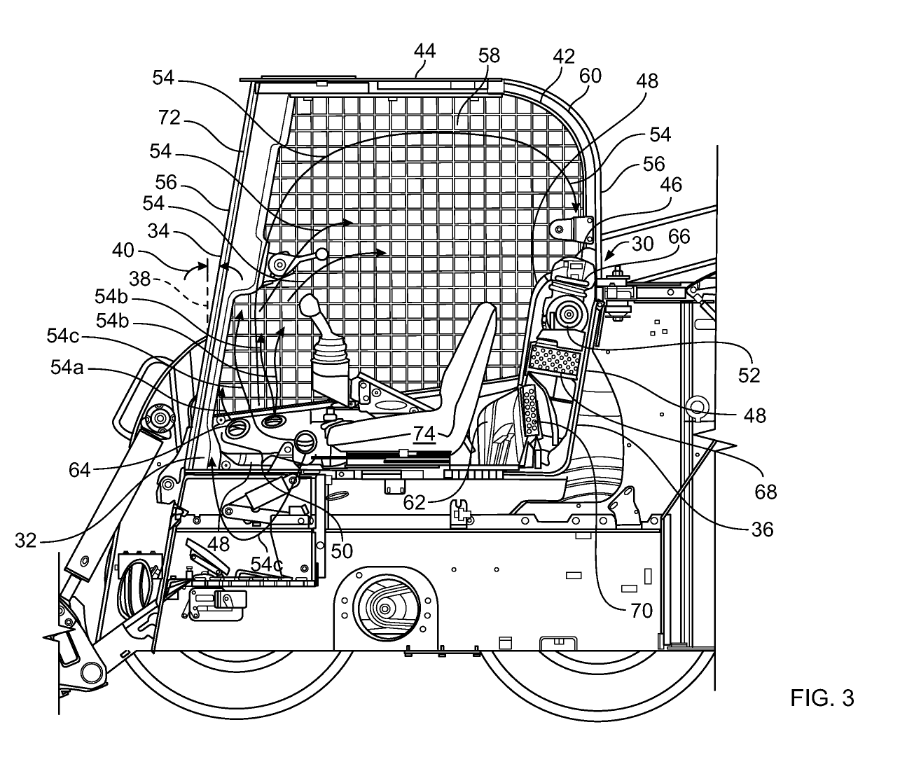

FIGS. 2-3 show different views of cab 20 and associated structure. Cab 20 includes an HVAC system 30 to provide environmental comfort to an operator positioned within the cab. In addition, HVAC system 30, in combination with unique structural features of cab 20, provides a recirculating airflow 54 sufficient to remove a non-transparent layer 56 of a phase of evaporable matter forming on a surface of a forward viewing region 34, a rear viewing region 42 and side viewing regions 58. For purposes of the disclosure, circulating airflow and recirculating airflow or the like may be used interchangeably.

Cab 20 includes a forward portion 32 for supporting a forward viewing region 34, such as a substantially transparent door, which not only provides an operator with enhanced viewing capability, but also providing an enclosure so that HVAC system 30 may be utilized to provide environmental comfort to the operator. Side viewing region 58 extends from forward portion 32 to rear portion 36 of the cab 20. In one embodiment, side viewing region 58 is composed of a substantially transparent material, such as tempered glass, to provide operator viewing capability, while also providing an enclosure for operator comfort. Cab 20 has a rear portion 36 that includes a rear viewing region 42, provided for similar reasons as the forward viewing region 34 and side viewing regions 58.

Forward viewing region 34 is oriented at an angle 40 with respect to a vertically directed line 38. As shown in FIG. 3, angle 40 is upwardly sloped toward rear portion 36 and approximately 10 degrees, although in other embodiments the angle may be greater than or less than 10 degrees. As further shown in FIG. 3, forward viewing region 34 is substantially planar, although in another embodiment the forward viewing region may include a curved profile so the angle between a vertically directed line 38 and its forward viewing region may vary, but will generally define an acute angle between the forward viewing region 34 and rear viewing region 36. With forward viewing region 34 of 20 having a planar profile and a substantially horizontal top 44, the forward viewing region and top form an obtuse angle therebetween. Additionally, as shown in FIG. 3, side viewing regions 58 are substantially planar, although in another embodiment the side viewing regions may include a curved profile.

In contrast to forward viewing region 34 and side viewing regions 58, rear viewing region 42 that extends between top 44 and rear portion 36 of the cab includes a significant curved profile. As further shown in FIG. 3, rear viewing region 42 has a radius of about 12 inches, although in other embodiments the radius of curvature may be greater than or less than 12 inches. Curved cab structure 60 is provided to effectively provide lateral support to rear viewing region 42. Additionally, by virtue of the radius of curvature of cab structure 60 being substantially the same as the radius of curvature of rear viewing region 42, curved cab structure provides continuous lateral support to rear viewing region 42. Rear viewing region 42 terminates along rear portion 36 in close proximity to an inlet 46 of HVAC system 30.

It is to be understood that in one embodiment, the forward viewing region and top of the cab (and/or supporting structure) may form a curved profile similar to that of the rear viewing region.

HVAC system 30 includes a conduit 48 having inlet 46 positioned along an upper portion of the conduit, with inlet 46 positioned beneath, but in close proximity to rear viewing region 42. As further shown in FIGS. 2-3, conduit 48 is positioned substantially centered along the rear portion 36 of the cab behind the operator. Conduit 48 includes a filter 66 in close proximity to inlet 46, an air moving device 52, such as a fan, near the filter, as well as heat exchangers 68, 70, corresponding to respective condenser and evaporator coils of the HVAC system to condition the air to provide operator comfort.

As further shown in FIGS. 2-3, conduit 48 further extends to bifurcated portions 62 that extend along opposite sides of cab 20. Each bifurcated portion 62 of conduit 48 further extends to forward portion 32 of cab 20 having a forward cab structure 72 that supports forward viewing region 34. Each of the bifurcated portions 62 further includes a plurality of outlets 50 formed in the bifurcated portions located in close proximity to the forward portion 32. At least one outlet of the plurality of outlets 50 includes directionally adjustable louvers 64 to selectably control the direction of airflow from the outlet(s). As shown in FIG. 3 which corresponds to the right-hand portion of cab 20 from the perspective of an operator seated in the cab (the left-hand portion of the cab being symmetric to the right-hand portion), the plurality of outlets 50 is located near forward portion 32 and beneath side viewing regions 58 in substantial vertical alignment with an operator's chair 74. As further shown in FIG. 3, the plurality of outlets 50 includes three outlets, generating initial respective airflows 54a, 54b, 54c that collectively define a circulating airflow 54 that flows from the plurality of outlets toward inlet 46. Recirculating airflow 54 is sufficient to remove a non-transparent layer 56 of a phase of an evaporable matter forming on a surface of any of the viewing regions. Although the non-transparent layer 56 may include solid, liquid or vapor phases of water, i.e., fog, frost and condensation, for purposes herein, the non-transparent layer primarily involves solid or vapor phases of water (fog and frost).

For example, European Standard EN 474-5.3.2.7 (2009) states that frosting systems require: “Machine with a cab shall provide facilities to defrost the front and rear window(s), for example by means of a heating system or a particular defrosting device. NOTE A testing method of windscreen defrosting system is described in ISO 10263-5:2007.” For conventional HVAC system constructions in Europe, an additional heating component may be required to satisfy the heating standard. The heating component may include an HVAC subsystem, such as a dedicated outlet vent for the front window, with considerable cost added to the machine when the subsystem includes an electrical grid heater or a dedicated outlet vent is used to meet the requirement. The circulating airflow 54 meets the current European Standard without requiring an HVAC subsystem or heating component that at least partially covers or is embedded in at least one of the forward, rear or side viewing regions, or is otherwise dedicated to operate independent of the rest of HVAC system and is associated with at least one of the forward, rear or side viewing regions.

The novel circulating airflow 54 associated with the airflow between the plurality of outlets 50 and the inlet 46 is due to the arrangement of conduit 48, in combination with the arrangement of forward viewing region 34 and curved rear viewing region 42. Forward viewing region 34, which typically also serves as a door, is oriented at an angle sloping toward rear portion 36 of the cab. As previously discussed, in one embodiment, the forward viewing region 34 angle is oriented about 10 degrees from vertical, and the rear viewing region 42 includes a prominent curved profile. When these features are combined, airflow in the cab can be forced into a flow pattern or airflow 54 by careful positioning of the plurality of outlets that direct the airflow toward inlet 46 so that air conditioned by the HVAC system, i.e., warm air, will naturally pass over the rear viewing region 42. By directing the airflow 54a, 54b, 54c from the plurality of outlets 50 low and toward the front of the cabin and having the recirculation inlet or inlet 46 positioned under the rear viewing region 42, a circular airflow pattern 54 from front to back of the cab is created. Airflow 54 is enhanced or aided by the slight rearword angle of forward viewing region 54 supported by forward cab structure 72 and curvature of rear viewing region 42.

It is to be understood that the plurality of outlets may include more than three or less than three outlets, with any of the outlets sized differently from each other or located in a position different than as shown. It is also to be understood that the right-hand portion of the cab may not be symmetric with the left-hand portion of the cab.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An HVAC system for a cab of a work vehicle comprising:
a forward portion of the cab including a forward viewing region, the forward viewing region generally oriented at an acute angle sloping toward a rear portion of the cab;
a curved rear viewing region extending between a top of the cab and the rear portion of the cab;
an inlet of the HVAC system positioned along the rear portion of the cab beneath the rear viewing region;
a conduit extending from the inlet toward the forward portion of the cab, the conduit including a plurality of outlets formed near the forward portion of the cab;
an air moving device positioned inside the conduit for urging airflow from the plurality of outlets toward the inlet;
the airflow between the plurality of outlets and the inlet is configured to circulate along the forward viewing region toward the rear viewing region to remove a non-transparent layer of a phase of evaporable matter forming on a surface from the forward viewing region and the rear viewing region without a heating component at least partially covering or embedded in at least one of the forward viewing region and the rear viewing region.

2. The system of claim 1, wherein the cab comprises opposed side viewing regions positioned between the forward viewing region and the rear viewing region, the airflow between the plurality of outlets and the inlet is configured to circulate along the forward viewing region, the side viewing regions and toward the rear viewing region to remove a non-transparent layer of a phase of evaporable matter forming on a surface from the forward viewing region, the rear viewing region and the side viewing regions without a heating component at least partially covering or embedded in at least one of the forward viewing region, the rear viewing region and the side viewing regions.

3. The system of claim 1, wherein curved cab structure extending between the top of the cab and the rear portion of the cab is configured to provide continuous lateral support to opposed sides of the rear viewing region.

4. The system of claim 3, wherein the profile of the curved cab structure is substantially the same as the profile of the rear viewing region.

5. The system of claim 1, wherein the conduit includes bifurcated portions extending between the inlet and the forward portion of the cab.

6. The system of claim 5, wherein the bifurcated portions extend toward the forward portion of the cab along opposed sides of the cab.

7. The system of claim 6, wherein the bifurcated portions include a plurality of outlets formed near the forward portion of the cab.

8. The system of claim 7, wherein at least one outlet of the plurality of outlets includes directionally adjustable louvers.

9. The system of claim 1, wherein the forward viewing region is oriented at an angle of about 10 degrees from vertical.

10. A work vehicle comprising:
a motor secured to a frame for activating a driving device for selectably moving the frame;
an operator cab supported by the frame;
an HVAC system for a cab of a work vehicle comprising:
a forward portion of the cab including a forward viewing region, the forward viewing region generally oriented at an acute angle sloping toward a rear portion of the cab;
a curved rear viewing region extending between a top of the cab and the rear portion of the cab;
an inlet of the HVAC system positioned along the rear portion of the cab beneath the rear viewing region;
a conduit extending from the inlet toward the forward portion of the cab, the conduit including a plurality of outlets formed near the forward portion of the cab;
an air moving device positioned inside the conduit for urging airflow from the plurality of outlets toward the inlet;
the airflow between the plurality of outlets and the inlet is configured to circulate along the forward viewing region toward the rear viewing region to remove a non-transparent layer of a phase of evaporable matter forming on a surface from the forward viewing region and the rear viewing region without a heating component at least partially covering or embedded in at least one of the forward viewing region and the rear viewing region.

11. The work vehicle of claim 10, wherein the cab comprises opposed side viewing regions positioned between the forward viewing region and the rear viewing region, the airflow between the plurality of outlets and the inlet is configured to circulate along the forward viewing region, the side viewing regions and toward the rear viewing region to remove a non-transparent layer of a phase of evaporable matter forming on a surface from the forward viewing region, the rear viewing region and the side viewing regions without a heating component at least partially covering or embedded in at least one of the forward viewing region, the rear viewing region and the side viewing regions.

12. The work vehicle of claim 10, wherein curved cab structure extending between the top of the cab and the rear portion of the cab is configured to provide continuous lateral support to opposed sides of the rear viewing region.

13. The work vehicle of claim 12, wherein the profile of the curved cab structure is substantially the same as the profile of the rear viewing region.

14. The work vehicle of claim 10, wherein the conduit includes bifurcated portions extending between the inlet and the forward portion of the cab.

15. The work vehicle of claim 14, wherein the bifurcated portions extend toward the forward portion of the cab along opposed sides of the cab.

16. The work vehicle of claim 15, wherein the bifurcated portions include a plurality of outlets formed near the forward portion of the cab.

17. The work vehicle of claim 16, wherein at least one outlet of the plurality of outlets includes directionally adjustable louvers.

18. The work vehicle of claim 1, wherein the forward viewing region is oriented at an angle of about 10 degrees from vertical.

19. A work vehicle comprising:
a motor secured to a frame for activating a driving device for selectably moving the frame;
an operator cab supported by the frame;
an HVAC system for a cab of a work vehicle comprising:
a forward portion of the cab including a forward viewing region, the forward viewing region generally oriented at an acute angle sloping toward a rear portion of the cab;
a curved rear viewing region extending between a top of the cab and the rear portion of the cab;
an inlet of the HVAC system positioned along the rear portion of the cab beneath the rear viewing region;
a conduit extending from the inlet toward the forward portion of the cab, the conduit including a plurality of outlets formed near the forward portion of the cab, the conduit includes bifurcated portions extending between the inlet and the forward portion of the cab;
an air moving device positioned inside the conduit for urging airflow from the plurality of outlets toward the inlet;
the airflow between the plurality of outlets and the inlet is configured to circulate along the forward viewing region toward the rear viewing region to remove a non-transparent layer of a phase of evaporable matter forming on a surface from the forward viewing region and the rear viewing region without a heating component at least partially covering or embedded in at least one of the forward viewing region and the rear viewing region.

20. The work vehicle of claim 19, wherein the forward viewing region is oriented at an angle of about 10 degrees from vertical.
